(19) United States
(12) Patent Application Publication
(10) Pub. No.: US 2025/0185542 A1
(43) Pub. Date: Jun. 12, 2025

(54) WINDROWER IMPLEMENT WITH MERGER ATTACHMENT

(71) Applicant: DEERE & COMPANY, MOLINE, IL (US)

(72) Inventors: MAHESH SOMAROWTHU, PUNE (IN); Ashwini Phalke, PUNE (IN); Abdul Kashaf H. Mohammed, HANAMKONDA (IN)

(21) Appl. No.: 18/536,559

(22) Filed: Dec. 12, 2023

(51) Int. Cl. A01D 43/10; A01D 57/20

(52) U.S. Cl. CPC A01D 43/102; A01D 43/105; A01D 57/20

(57) ABSTRACT

A windrower implement includes an actuation system coupled to a rotating element of a crop conditioning system for controlling a position of the rotating element to define a processing gap. A first hydraulic motor is coupled to the rotating element. A merger attachment includes a driven roller rotatably supporting a conveyor. A second hydraulic motor is coupled to the driven roller. A controller is configured to determine a current value of a first fluid pressure of the first hydraulic motor and a current value of a second fluid pressure of the second hydraulic motor, and compare the respective fluid pressures to respective thresholds. When the current value of the either the first or second fluid pressure is greater than their respective threshold, the controller controls the actuation system to increase the processing gap to prevent plugging of the crop conditioning system.

### TECHNICAL FIELD

The disclosure generally relates to a windrower implement for cutting, processing, and forming swaths of cut crop material.

### BACKGROUND

A windrower implement is an agricultural machine that includes an implement head operable to cut and process standing crop material while moving through a field, and form the cut crop material into a swath or windrow. Typically, the windrower implement forms the windrow on and along a general longitudinal centerline of the windrower implement, generally between the left and right ground engaging devices, e.g., tires or tracks.

The windrower implement may be equipped with a merger attachment. The merger attachment is configured to form the windrow laterally offset from the centerline of the windrower implement, generally outside the left or right ground engaging devices. The merger attachment may be deployed to form the windrow at an offset position relative to the centerline of the windrower implement, or may be stowed and disengaged, whereby the windrow is formed generally along the centerline of the windrower implement.

The head implement includes a crop conditioning system that processes the cut crop material by scraping, cracking and/or fracturing the stem portions of the crop material to reduce dry down time and/or increase digestibility of the crop material. The crop conditioning system includes a rotating element that is positioned relative to another component to define a crop processing gap therebetween. A position of the rotating element may be controlled to set and/or define the processing gap to a desired processing gap based on various factors, such as but not limited to, crop type, crop density, moisture content, vehicle speed, etc. During operation, crop material may become plugged within the processing gap of the crop conditioning system. For example, if the crop density increases, thereby increasing the volume/rate of crop material passing through the crop conditioning system, the crop material may become plugged within the processing gap, requiring the operator to stop operation of the windrower implement and manually clear the blockage. Clearing a plug or blockage within the crop conditioning system requires significant downtime which is undesirable.

### SUMMARY

A windrower implement is provided. The windrower implement includes a frame extending along a central longitudinal axis between a forward end and a rearward end relative to a direction of travel during operation. An implement head is attached to the frame proximate the forward end thereof. The implement head includes a cutter configured for cutting standing crop material and a crop conditioning system having a rotating element configured for processing the crop material. The implement head is configured to discharge the crop material from the crop conditioning system in a rearward direction along the central longitudinal axis. An actuation system is coupled to the rotating element of the crop conditioning system. The actuation system is selectively controllable to control a position of the rotating element relative to another component to define a processing gap between the rotating element and the another component for moving the crop material therethrough. A first hydraulic motor is coupled to the rotating element of the crop conditioning system. The first hydraulic motor is operable in response to a first fluid pressure to rotate the rotating element of the crop conditioning system. A controller includes a processor and a memory having a plug prevention algorithm stored thereon. The processor is operable to execute the plug prevention algorithm to determine a current value of the first fluid pressure of the first hydraulic motor, and compare the current value of the first fluid pressure of the first hydraulic motor to a first threshold value. When the current value of the first fluid pressure of the first hydraulic motor is greater than the first threshold value, the controller is configured to control the actuation system to increase the processing gap from a desired processing gap.

Increased volumes of crop material moved through the crop conditioning system may be associated with an increased likelihood of plugging the crop conditioning system, and may be associated with a corresponding increase in the fluid pressure of the first hydraulic motor. As such, increasing the processing gap from the desired processing gap to an increased size when the fluid pressure of the first hydraulic motor is above the first threshold value allows more crop material through the processing gap, thereby reducing the likelihood of the crop conditioning system plugging.

In one aspect of the disclosure, the processor may be operable to execute the plug prevention algorithm to determine and/or define the desired processing gap. The desired processing gap may be defined as the desired distance between the rotating element of the crop conditioning system and another component, such as but not limited to a second roller or a stationary plate. The desired processing gap may be defined to achieve a desired level/amount of crop processing for the crop material, and may depend upon, but is not limited to, the type of crop material, the volume or rate of processing the crop material, a moisture content of the crop material, etc. In one implementation, the processor may be operable to execute the plug prevention algorithm to determine and/or define the desired processing gap by receiving a commanded processing gap from an operator via an input device. In another implementation, the processor may be operable to execute the plug prevention algorithm to automatically determine the desired processing gap based on at least one sensed crop characteristic.

In one aspect of the disclosure, when the current value of the first fluid pressure of the first hydraulic motor decreases below the first threshold value, the processor may be operable to execute the plug prevention algorithm to control the actuation system to decrease the processing gap from the increased processing gap value to the desired processing gap. Accordingly, when the current value of the first fluid pressure of the first hydraulic motor increases above the first threshold value, thereby indicating increased pressure applied to the first hydraulic motor which may indicate a higher likelihood of plugging the crop conditioning system, the controller may increase the processing gap to allow more crop material therethrough and prevent plugging of the crop conditioning system. When the current value of the first fluid pressure of the first hydraulic motor decreases to below the first threshold value, thereby indicating decreased pressure applied to the first hydraulic motor which may indicate a lower likelihood of plugging the crop conditioning system, the controller may decrease the processing gap from the increased level back down to the desired processing gap to resume the desired level or amount of crop processing.

The windrower implement may include a first pressure sensor that is configured for detecting fluid pressure at the first hydraulic motor. The first pressure sensor is disposed in communication with the controller for communicating data thereto. The first pressure sensor may include a sensor capable of detecting data related to the fluid pressure applied to the first hydraulic motor. For example, the first pressure sensor may include, but is not limited to, a pressure sensor arranged to directly sense fluid pressure of the fluid flowing to the first hydraulic motor. In other implementations, the first pressure sensor may include, but is not limited to, a strain gauge measuring strain and/or torque of a component of the motor, which may be related to the fluid pressure applied to the first hydraulic motor. It should be appreciated that the first pressure sensor may include some other type and/or configuration of sensor not described or mentioned herein.

In one aspect of the disclosure, the windrower implement may further include a merger attachment. The merger attachment is coupled to the frame rearward of the implement head. The merger attachment includes a driven roller supporting a conveyor. The driven roller is rotatably driven and transfers rotation to the conveyor to move the conveyor. The conveyor is arranged to rotate in an endless loop, and is positioned relative to the implement head to receive the crop material discharged from the implement head. The conveyor is configured to convey the crop material laterally relative to the central longitudinal axis to form a windrow laterally offset from the central longitudinal axis. A second hydraulic motor may be coupled to the driven roller of the merger attachment. The second hydraulic motor is operable in response to a second fluid pressure to rotate the driven roller of the merger attachment, to thereby rotate the conveyor. Increased volumes/weight of crop material moved by the conveyor may be associated with an increased likelihood of plugging the crop conditioning system, and may be associated with a corresponding increase in the fluid pressure of the second hydraulic motor.

In one aspect of the disclosure, the processor may be operable to execute the plug prevention algorithm to determine a current value of the second fluid pressure of the second hydraulic motor, and compare the current value of the second fluid pressure of the second hydraulic motor to a second threshold value. When the current value of the second fluid pressure of the second hydraulic motor is greater than the second threshold value, the controller may control the actuation system to increase the processing gap from the desired processing gap to an increased size.

Increased weight of crop material moved by the conveyor of the merger attachment may indicate a corresponding increased volume of crop material moved through the crop conditioning system. This increased volume of crop material may be associated with an increased likelihood of plugging the crop conditioning system. The increased weight of crop material moved by the conveyor may be associated with a corresponding increase in the second fluid pressure of the second hydraulic motor. As such, increasing the processing gap from the desired processing gap to an increased size when the fluid pressure of the second hydraulic motor is above the second threshold value allows more crop material through the processing gap, thereby reducing the likelihood of the crop conditioning system plugging.

In one aspect of the disclosure, when the current value of the second fluid pressure of the second hydraulic motor decreases below the second threshold value, the processor may be operable to execute the plug prevention algorithm to control the actuation system to decrease the processing gap from the increased processing gap value to the desired processing gap. Accordingly, when the current value of the second fluid pressure of the second hydraulic motor increases above the second threshold value, thereby indicating increased pressure applied to the second hydraulic motor which may indicate a higher likelihood of plugging the crop conditioning system, the controller may increase the processing gap to allow more crop material therethrough and prevent plugging of the crop conditioning system. When the current value of the second fluid pressure of the second hydraulic motor decreases to below the second threshold value, thereby indicating decreased pressure applied to the second hydraulic motor which may indicate a lower likelihood of plugging the crop conditioning system, the controller may decrease the processing gap from the increased level back down to the desired processing gap to resume the desired level or amount of crop processing.

The windrower implement may include a second pressure sensor that is configured for detecting fluid pressure at the second hydraulic motor. The second pressure sensor is disposed in communication with the controller for communicating data thereto. The second pressure sensor may include a sensor capable of detecting data related to the fluid pressure applied to the second hydraulic motor. For example, the second pressure sensor may include, but is not limited to, a pressure sensor arranged to directly sense fluid pressure of the fluid flowing to the second hydraulic motor. In other implementations, the second pressure sensor may include, but is not limited to, a strain gauge measuring strain and/or torque of a component of the motor, which may be related to the fluid pressure applied to the second hydraulic motor. It should be appreciated that the second pressure sensor may include some other type and/or configuration of sensor not described or mentioned herein.

In one aspect of the disclosure, the actuation system may include an actuator that is selectively moveable in response to a control signal from the controller for moving the rotating element of the crop conditioning system. In one implementation, the actuator may include a linear actuator that generates linear movement, such as but not limited to, an electric linear actuator or a hydraulic cylinder. In another implementation, the actuator may include a rotary actuator that generates a rotational movement, such as but not limited to an electric motor or hydraulic motor that generates a rotational output. It should be appreciated that the actuation system may further include all links, connections, levers, brackets, chains, belts, gears, sprockets, etc., necessary to connect the actuator with the rotating element for moving the rotating element toward and away from the another component.

In one aspect of the disclosure, the windrower implement may further include a motion sensor that is coupled to one of the implement head and the merger attachment. The motion sensor may be configured to detect vibration of the one of the implement head and the merger attachment to which the motion sensor is attached. In one implementation, the motion sensor may include, but is not limited to, an accelerometer operable to detect acceleration in up to three dimensions. The processor may be operable to execute the plug prevention algorithm to determine a current magnitude of vibration in the one of the implement head and the merger attachment to which the motion sensor is attached from data sensed from the motion sensor. The controller may then compare the current magnitude of vibration to a vibration threshold value, and control the actuation system to increase the processing gap when the current magnitude of the vibration is greater than the vibration threshold value.

A controller for a windrower implement is also provided. The controller includes a processor and a memory having a plug prevention algorithm stored thereon. The processor is operable to execute the plug prevention algorithm to determine a desired processing gap. The controller may further determine a current value of a first fluid pressure of a first hydraulic motor coupled to a rotating element of a crop conditioning system of the windrower implement, and compare the current value of the first fluid pressure of the first hydraulic motor to a first threshold value. The controller may further determine a current value of a second fluid pressure of a second hydraulic motor coupled to a driven roller of a merger attachment of the windrower implement, and compare the current value of the second fluid pressure of the second hydraulic motor to a second threshold value. When one of the current value of the first fluid pressure of the first hydraulic motor is greater than the first threshold value, or when the current value of the second fluid pressure of the second hydraulic motor is greater than the second threshold value, the controller may be configured to control the actuation system to increase the processing gap from the desired processing gap to an increased distance to allow an increased amount of crop material through the crop conditioning system, thereby reducing the risk of the crop conditioning system plugging.

In one aspect of the disclosure, when the one of the current value of the first fluid pressure of the first hydraulic motor decreases below the first threshold value or the current value of the second fluid pressure of the second hydraulic motor decreases below the second threshold value, the processor may be operable to execute the plug prevention algorithm to control the actuation system to decrease the processing gap from the increased distance back down to the desired processing gap. The controller may decrease the processing gap when both the current value of the first fluid pressure of the first hydraulic motor is below the first threshold value and the current value of the second fluid pressure of the second hydraulic motor is below the second threshold value to resume the desired level or amount of crop processing.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a windrower implement.

FIG. 2 is a schematic partial cross-sectional view of the windrower implement.

FIG. 3 is an enlarged schematic cross-sectional view of the windrower implement showing a crop conditioning system defining a desired processing gap.

FIG. 4 is an enlarged schematic cross-sectional view of the windrower implement showing the crop conditioning system defining an increased processing gap distance.

FIG. 5 is a flow chart representing a method of controlling the windrower implement.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

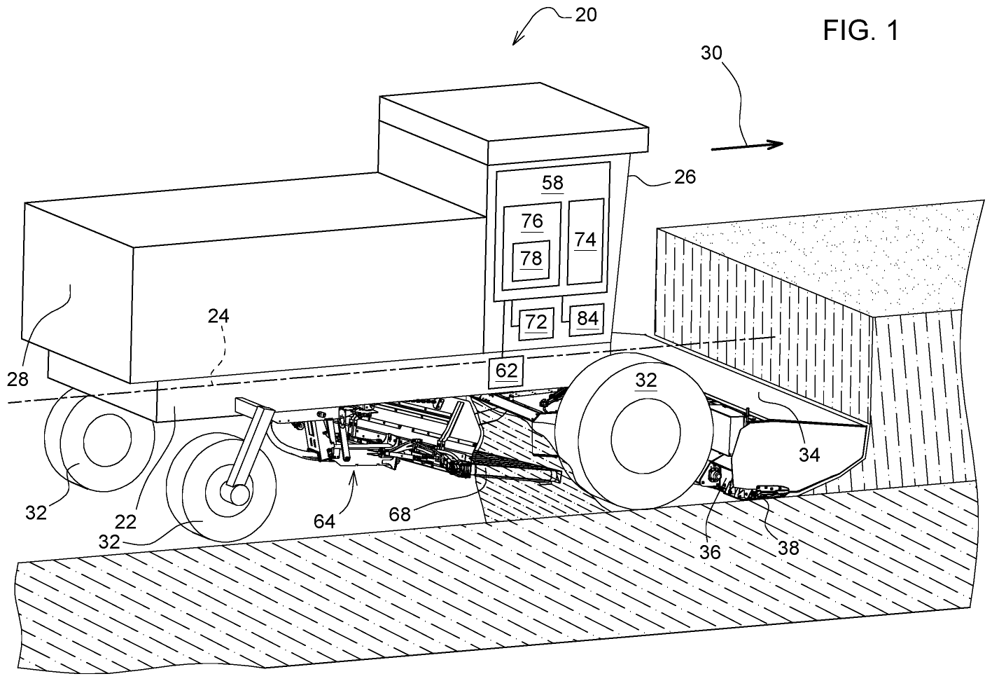

Referring to the Figures, wherein like numerals indicate like parts throughout the several views, a windrower implement 20 is generally shown at 20 in FIG. 1. The exemplary embodiment of the windrower implement 20 shown in the Figures is configured as a self-propelled windrower. However, it should be appreciated that the teachings of this disclosure may be applied to other platforms, such as but not limited to, a drawn implement configured for connection to a tractor. In one implementation, the windrower implement 20 is operable to mow and collect standing crop material in a field, condition the cut crop material as it moves through the windrower implement 20 to improve is drying characteristics, and then return the conditioned, cut crop material to the field in a windrow or swath.

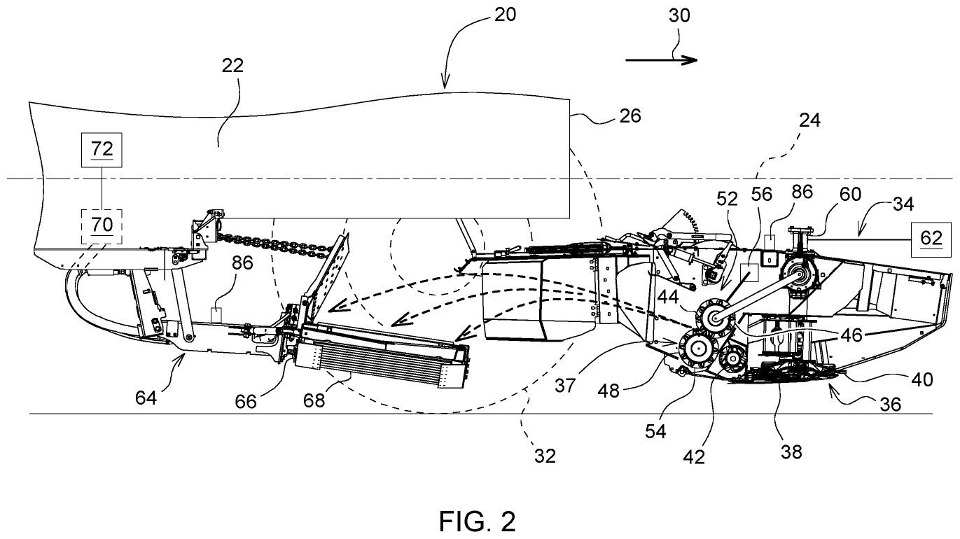

Referring to FIGS. 1 and 2, the example implementation of the windrower implement 20 includes a frame 22. The frame 22 extends along a central longitudinal axis 24 between a forward end 26 and a rearward end 28 relative to a direction of travel 30 during operation. The central longitudinal axis 24 defines a longitudinal centerline of the windrower implement 20. The frame 22 may include, but is not limited to, the various members, panels, supports, braces, beams, etc., necessary to support the various components and systems of the windrower implement 20 as described below. The windrower implement 20 includes ground engaging devices 32, e.g., tires and/or tracks, which support the frame 22 relative to a ground surface. The ground engaging devices 32 may be powered to move the windrower implement 20 across the ground surface.

The windrower implement 20 further includes an implement head 34. The implement head 34 is attached to the frame 22 proximate the forward end 26 of the frame 22. The implement head 34 includes a cutting mechanism 36 configured for cutting the standing crop material in the field, and a crop conditioning system 37 configured for conditioning the crop material. Conditioning the crop material may include, but is not limited to, bending, cracking fracturing, and/or scraping the stem portions of the crop material to reduce dry down time and/or increase digestibility of the crop material. The implement head 34 is configured to discharge the crop material in a rearward direction generally along the central longitudinal axis 24.

The cutting mechanism 36 may be referred to herein as the cutter 36. The cutting mechanism 36 is coupled to the frame 22 and is operable to cut standing crop material in a field. The cutting mechanism 36 may include any mechanism that is capable of cutting the crop material. For example, the cutting mechanism 36 may be embodied as a rotary disc cutter bar 38. However, the cutting mechanism 36 is not limited to the exemplary embodiment of the rotary disc cutter bar 38. As such, it should be appreciated that the cutting mechanism 36 may vary from the exemplary embodiment noted herein.

As understood in the art, the rotary disc cutter bar 38 is supported by the frame 22. The cutter bar 38 extends along an axis that is disposed generally transverse to the direction of travel 30 of the windrower implement 20. The cutter bar 38 includes a plurality of cutting discs 40 spaced along the cutter bar 38 for rotation about respective vertical axes. Each of the cutting discs 40 is coupled to a drivetrain to which power is coupled for causing them to rotate in appropriate directions, for delivering cut crop material to an auger 42 disposed rearward of the cutting mechanism 36.

The auger 42 may pass the crop material rearward to the crop conditioning system 37. In particular, the auger 42 may be positioned in front of and lower than the crop conditioning system 37. In operation, the design of the auger 42 enables the delivery of cut crop material into the crop conditioning system 37. The cutting mechanism 36 delivers cut crop material to the auger 42, which in turn may deliver the cut crop material rearward for further processing by the crop conditioning system 37.

The crop conditioning system 37 includes a rotating element 44 that is configured for processing and/or conditioning the crop material as the crop material moves through the crop conditioning system 37. The crop conditioning system 37 may include, but is not limited to, an impeller style conditioning system or a pair of counter rotating conditioner rolls, as is understood in the art. If the crop conditioning system 37 is configured as an impeller style conditioning system, then the rotating element 44 may include a cylinder that is rotatably driven for rotation about its longitudinal diametric axis. The cylinder includes a plurality of flails disposed about the outer periphery of the cylinder. The crop material moves between the impeller hood and the cylinder. As such, the distance between the cylinder and the impeller hood may define a processing gap 50. The flails scrape the crop material against an impeller hood as the crop material moves between the impeller hood and the cylinder to condition and/or process the crop material as is understood by those skilled in the art.

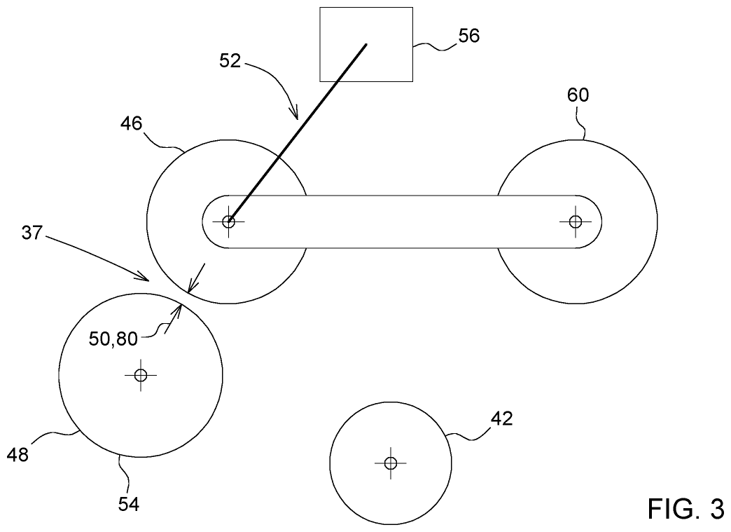

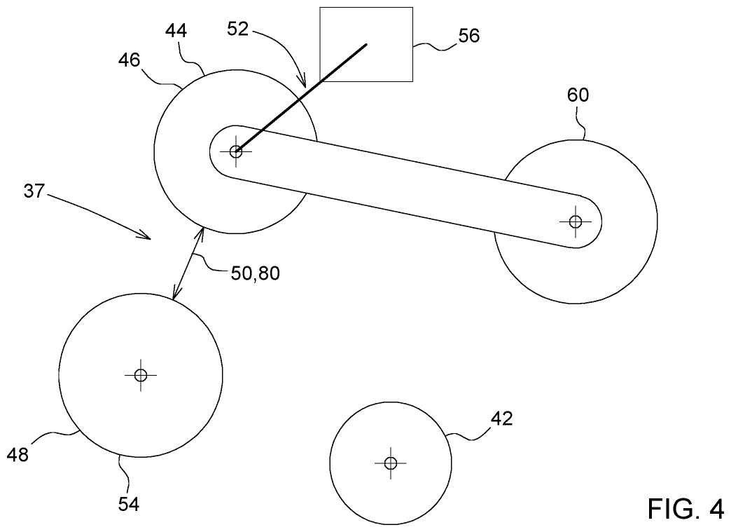

If the crop conditioning system 37 is configured as a pair of counter-rotating conditioning rolls, such as shown in FIG. 2, then the rotating element 44 may include one of the conditioning rolls. For example, referring to FIGS. 3 and 4, the rotating element 44 may include a first conditioning roll 46 that is spaced from a second conditioning roll 48 by a distance. The distance separating the first conditioning roll 46 and the second conditioning roll 48 may be defined as the processing gap 50 through which the crop material passes. The first conditioning roll 46 and the second conditioning roll 48 are rotated about their respective longitudinal axis in different rotational directions to generate a shear force therebetween. The crop material passes through the processing gap 50, between the first conditioning roll 46 and the second conditioning roll 48, whereby the shearing action therebetween conditions and/or processes the crop material.

The conditioned crop material is expelled rearward along the central longitudinal axis 24 by the crop conditioning system 37, and may be formed into the windrow or swath by upright right and left forming boards and a horizontal swath board. The cut and conditioned crop material is expelled or discharged from the crop conditioning system 37 in the rearward direction, whereafter the crop material moves a short distance through the air before accumulating on the ground in the formed windrow.

Referring to FIGS. 2-4, the windrower implement 20 may further include an actuation system 52. The actuation system 52 is coupled to the rotating element 44 of the crop conditioning system 37 and selectively controllable to control a position of the rotating element 44 relative to another component 54. The position of the rotating element 44 relative to the another component 54 is adjusted to control and/or define the processing gap 50 between the rotating element 44 and the another component 54 for moving the crop material therethrough. The another component 54 may be defined as the impeller hood of the impeller style crop conditioning system 37, or may alternatively be defined as the second conditioning roll 48 of the counter-rotating conditioner roll system. The actuation system 52 includes an actuator 56 that is selectively moveable in response to a control signal from a controller 58. Movement of the actuator 56 controls movement of the rotating element 44 of the crop conditioning system 37 relative to the another component 54.

The actuator 56 may include any device and associated components that are capable of moving and/or controlling the position of the rotating element 44 relative to the another component 54. In one implementation, the actuator 56 may include a linear actuator 56 that generates linear movement, such as but not limited to, an electric linear actuator 56 or a hydraulic cylinder. In another implementation, the actuator 56 may include a rotary actuator 56 that generates a rotational movement, such as but not limited to an electric motor or hydraulic motor that generates a rotational output. It should be appreciated that the actuation system 52 may further include all links, connections, levers, brackets, chains, belts, gears, sprockets, etc., necessary to connect the actuator 56 with the rotating element 44 for moving the rotating element 44 toward and away from the another component 54.

Referring to FIG. 2, a first hydraulic motor 60 may be coupled to the rotating element 44 of the crop conditioning system 37. The first hydraulic motor 60 is operable in response to a first fluid pressure to rotate the rotating element 44 of the crop conditioning system 37. It should be appreciated that the first hydraulic motor 60 may be coupled to the rotating element 44 in a suitable manner using, for example, a chain and sprocket system, a belt and pulley system, a gear drive system, a direct attachment, etc. The first hydraulic motor 60 receives a fluid flow at the first fluid pressure and generates a rotational output which is used to rotate the rotating element 44, e.g., the cylinder of the impeller style conditioning system or the first conditioning roll 46 of the counter-rotated conditioning system. The first fluid pressure may vary in response to the load on the rotating element 44. For example, as the load on the rotating element 44 increases, the first fluid pressure at the first hydraulic motor 60 may increase correspondingly. Similarly, as the load on the rotating element 44 decreases, the first fluid pressure at the first hydraulic motor 60 may decrease correspondingly. It should be appreciated that the load on the rotating element 44 may vary based upon the volume and/or mass of the crop material moving through the crop conditioning system 37, and particularly the volume and/or mass of the crop material moving through the processing gap 50, with higher volumes and/or mass of crop material increasing the load on the rotating element 44, and thereby increasing the first fluid pressure at the first hydraulic motor 60.

The windrower implement 20 may further include a first pressure sensor 62 that is configured for detecting fluid pressure at the first hydraulic motor 60. The first pressure sensor 62 may be disposed in communication with the controller 58 for communicating data thereto. The first pressure sensor 62 may include a sensor capable of detecting data related to the fluid pressure applied to the first hydraulic motor 60. For example, the first pressure sensor 62 may include, but is not limited to, a pressure sensor arranged to directly sense fluid pressure of the fluid flowing to the first hydraulic motor 60. In other implementations, the first pressure sensor 62 may include, but is not limited to, a strain gauge measuring strain and/or torque of a component of the motor, which may be related to the fluid pressure applied to the first hydraulic motor 60. It should be appreciated that the first pressure sensor 62 may include some other type and/or configuration of sensor configured for sensing some other type of data related to the first fluid pressure not described or mentioned herein.

Referring to FIGS. 1 and 2, the windrower implement 20 includes a merger attachment 64. The merger attachment 64 is coupled to the frame 22 rearward of the implement head 34. The merger attachment 64 may include a driven roller 66 supporting a conveyor 68. The conveyor 68 is positioned relative to the crop conditioning system 37 to receive the crop material discharged from the crop positioning system of the implement head 34. The conveyor 68 is configured to move the crop material laterally relative to the central longitudinal axis 24 to form a windrow laterally offset from the central longitudinal axis 24.

The driven roller 66 of the merger attachment 64 is rotatably driven by a second hydraulic motor 70 coupled thereto. The second hydraulic motor 70 is operable in response to a second fluid pressure to rotate the driven roller 66 of the merger attachment 64. It should be appreciated that the second hydraulic motor 70 may be coupled to the driven roller 66 in a suitable manner using, for example, a chain and sprocket system, a belt and pulley system, a gear drive system, a direct attachment, etc. The second hydraulic motor 70 receives a fluid flow at the second fluid pressure and generates a rotational output which is used to rotate the driven roller 66. The second fluid pressure may vary in response to the load on the conveyor 68. For example, as the load on the conveyor 68 increases, the second fluid pressure at the second hydraulic motor 70 may increase correspondingly. Similarly, as the load on the conveyor 68 decreases, the second fluid pressure at the second hydraulic motor 70 may decrease correspondingly. It should be appreciated that the load on the conveyor 68 may vary based upon the volume and/or mass of the crop material being moved by the conveyor 68, with higher volumes and/or mass of crop material increasing the load on the conveyor 68, and thereby increasing the second fluid pressure at the second hydraulic motor 70.

The windrower implement 20 may further include a second pressure sensor 72 that is configured for detecting fluid pressure at the second hydraulic motor 70. The second pressure sensor 72 may be disposed in communication with the controller 58 for communicating data thereto. The second pressure sensor 72 may include a sensor capable of detecting data related to the fluid pressure applied to the second hydraulic motor 70. For example, the second pressure sensor 72 may include, but is not limited to, a pressure sensor arranged to directly sense fluid pressure of the fluid flowing to the second hydraulic motor 70. In other implementations, the second pressure sensor 72 may include, but is not limited to, a strain gauge measuring strain and/or torque of a component of the motor, which may be related to the fluid pressure applied to the second hydraulic motor 70. It should be appreciated that the second pressure sensor 72 may include some other type and/or configuration of sensor configured for sensing some other type of data related to the second fluid pressure not described or mentioned herein.

The conveyor 68 is rotatably driven by the driven roller 66, which is in turn rotatably driven by the second hydraulic motor 70. The conveyor 68 may include, for example, a rotatable endless belt, which is operable to convey the crop material laterally relative to the longitudinal centerline of the windrower implement 20, and deposit the crop material on the ground at a laterally offset position relative to the central longitudinal axis 24 of the frame 22 and the centerline of the windrower implement 20. The crop material is discharged from the crop conditioning system 37 of the implement head 34 and falls onto the conveyor 68 of the merger attachment 64. The conveyor 68 moves or rotates to move the crop disposed thereon laterally outward away from the centerline of the windrower implement 20. The crop on the conveyor 68 is deposited or discharged off a distal end of the conveyor 68, whereafter the crop falls to the ground forming the windrow which is laterally offset from the centerline of the windrower implement 20.

In one aspect of the disclosure, the windrower implement 20 may further include a motion sensor that is coupled to one of the implement head 34 and the merger attachment 64. The motion sensor may be configured to detect vibration of the one of the implement head 34 and the merger attachment 64 to which the motion sensor is attached. In one implementation, the motion sensor may include, but is not limited to, an accelerometer operable to detect acceleration in up to three dimensions. It should be appreciated that the motion sensor may be configured to include some other type of sensor not described herein that is capable of detecting data related to vibration, from which the controller 58 may identify excessive vibration.

The controller 58 is operatively coupled to the actuation system 52 for controlling the position of the rotating element 44, i.e., the processing gap 50. The controller 58 is operable to receive inputs and data signals, and communicate a control signal to the actuation system 52. While the controller 58 is generally described herein as a singular device, it should be appreciated that the controller 58 may include multiple devices linked together to share and/or communicate information therebetween. Furthermore, it should be appreciated that the controller 58 may be located on the windrower implement 20 or located remotely from the windrower implement 20.

The controller 58 may alternatively be referred to as a computing device, a computer, a controller 58, a control unit, a control module, a module, etc. The controller 58 includes a processor 74, a memory 76, and all software, hardware, algorithms, connections, sensors, etc., necessary to manage and control the operation of actuation system 52. As such, a method may be embodied as a program or algorithm operable on the controller 58. It should be appreciated that the controller 58 may include any device capable of analyzing data from various sensors, comparing data, making decisions, and executing the required tasks.

As used herein, “controller 58” is intended to be used consistent with how the term is used by a person of skill in the art, and refers to a computing component with processing, memory 76, and communication capabilities, which is utilized to execute instructions (i.e., stored on the memory 76 or received via the communication capabilities) to control or communicate with one or more other components. In certain embodiments, the controller 58 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The controller 58 may be in communication with other components on the windrower implement 20, such as hydraulic components, electrical components, and operator inputs within an operator station of the windrower implement 20 or an associated work vehicle. The controller 58 may be electrically connected to these other components wirelessly or by a wiring harness such that messages, commands, and electrical power may be transmitted between the controller 58 and the other components. Although the controller 58 is referenced in the singular, in alternative embodiments the configuration and functionality described herein can be split across multiple devices using techniques known to a person of ordinary skill in the art.

The controller 58 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 76 may include any non-transitory/tangible medium which participates in providing data or computer-readable instructions. The memory 76 may be non-volatile or volatile. Non-volatile media may include, for example, optical or magnetic disks and other persistent memory. Example volatile media may include dynamic random access memory (DRAM), which may constitute a main memory. Other examples of embodiments for memory 76 include a floppy, flexible disk, or hard disk, magnetic tape or other magnetic medium, a CD-ROM, DVD, and/or any other optical medium, as well as other possible memory devices such as flash memory.

The controller 58 includes the tangible, non-transitory memory 76 on which are recorded computer-executable instructions, including a plug prevention algorithm 78. The processor 74 of the controller 58 is configured for executing the plug prevention algorithm 78. The plug prevention algorithm 78 implements a method of controlling the crop conditioning system 37, described in detail below.

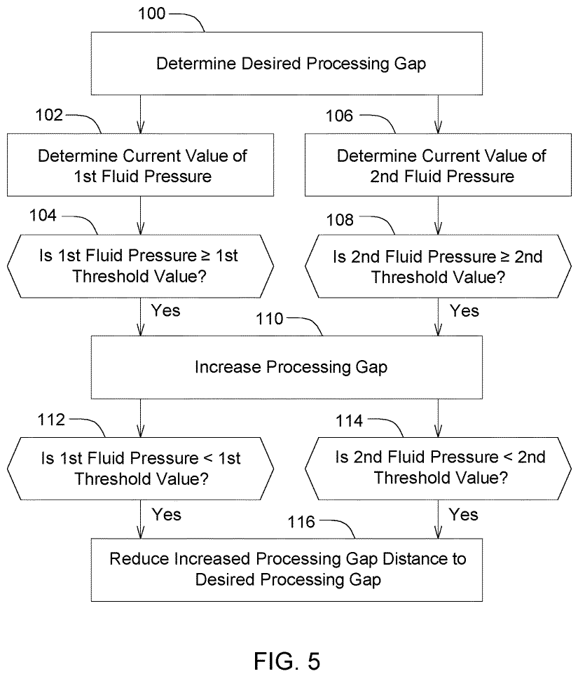

The method of controlling the crop conditioning system 37 may include the controller 58 defining and/or determining a desired processing gap 80, shown in FIG. 3. The step of determining the desired processing gap 80 is generally indicated by box 100 shown in FIG. 5. As noted above, the processing gap 50 is the distance between the rotating element 44 of the crop conditioning system 37 and the another component 54. The desired processing gap 80 may be defined to equal a value or distance to provide a desired amount or level of crop conditioning for the intended use and for the current crop material and harvest conditions. The desired processing gap 80 may depend upon the crop type, crop yield, harvest speed, moisture content, etc., and may be set to a value as understood by those skilled in the art. The controller 58 may define and/or determine the desired processing gap 80 by receiving a commanded processing gap 50 from an operator via an input device 84. For example, the operator may enter a value into a touchscreen display to set the desired processing gap 80. In other implementations, the controller 58 may automatically define and/or determine the desired processing gap 80 based on at least one sensed crop characteristic. For example, the controller 58 may estimate a yield, estimate a moisture content, sense a crop type, and using that information, the controller 58 may automatically determine and define the desired processing gap 80. Once the controller 58 has defined and/or determined the desired processing gap 80, the controller 58 may control the actuation system 52 to position the rotating element 44 of the crop conditioning system 37 relative to the another component 54 to achieve the desired processing gap 80 in preparation for harvest operations.

The controller 58 may monitor and determine a current value of the first fluid pressure of the first hydraulic motor 60 during the harvest operations from data sensed by the first pressure sensor 62. The step of determining the current value of the first fluid pressure is generally indicated by box 102 shown in FIG. 5. As described above, the first fluid pressure at the first hydraulic motor 60 will vary during operation based on the load applied to the rotating element 44 of the crop conditioning system 37. The first pressure sensor 62 communicates data to the controller 58 so that the controller 58 may determine a real time and continuous value of the current first fluid pressure during operation.

The controller 58 may compare the current value of the first fluid pressure of the first hydraulic motor 60 to a first threshold value. The step of comparing the current value of the first fluid pressure to the first threshold value is generally indicated by box 104 shown in FIG. 5. The first threshold value may be defined to equal a fluid pressure level indicative of a heightened risk of the crop material plugging the crop conditioning system 37. Accordingly, the controller 58 may compare the current value of the first fluid pressure of the first hydraulic motor 60 to the first threshold value to determine if the current value of the first fluid pressure is equal to or greater than the first threshold value, thereby indicating an increased risk of the crop material plugging the crop conditioning system 37, or determine if the current value of the first fluid pressure is less than the first threshold value, thereby indicating a reduced or low level of risk that the crop material may plug the crop conditioning system 37.

The controller 58 may monitor and determine a current value of the second fluid pressure of the second hydraulic motor 70 during the harvest operations from data sensed by the second pressure sensor 72. The step of determining the current value of the second fluid pressure is generally indicted by box 106 shown in FIG. 5. As described above, the second fluid pressure at the second hydraulic motor 70 will vary during operation based on the load applied to the conveyor 68 of the merger attachment 64. The second pressure sensor 72 communicates data to the controller 58 so that the controller 58 may determine a real time and continuous value of the current second fluid pressure during operation.

The controller 58 may compare the current value of the second fluid pressure of the second hydraulic motor 70 to a second threshold value. The step of comparing the current value of the second fluid pressure to the second threshold value is generally indicated by box 108 shown in FIG. 5. The second threshold value may be defined to equal a fluid pressure level indicative of a heightened risk of the crop material plugging the crop conditioning system 37. Accordingly, the controller 58 may compare the current value of the second fluid pressure of the second hydraulic motor 70 to the second threshold value to determine if the current value of the second fluid pressure is equal to or greater than the second threshold value, thereby indicating an increased risk of the crop material plugging the crop conditioning system 37, or determine if the current value of the second fluid pressure is less than the second threshold value, thereby indicating a reduced or low level of risk that the crop material may plug the crop conditioning system 37.

When one of the current value of the first fluid pressure of the first hydraulic motor 60 is greater than the first threshold value, or when the current value of the second fluid pressure of the second hydraulic motor 70 is greater than the second threshold value, the controller 58 may communicate a control signal to the actuation system 52 to control the actuation system 52 to increase the processing gap 50 from the desired processing gap 80 to a greater distance, i.e., an increased processing gap distance 82, shown in FIG. 4. The step of increasing the processing gap 50 is generally indicated by box 110 shown in FIG. 5. For example, when the current value of the first fluid pressure of the first hydraulic motor 60 is greater than the first threshold value, thereby indicating that the load on the rotating element 44 of the crop conditioning system 37 is increased to a level that may indicate a likelihood of the crop material plugging the crop conditioning system 37, the controller 58 may control the actuation system 52 to increase the processing gap 50 from the desired processing gap 80 to the increased processing gap distance 82. Similarly, when the current value of the second fluid pressure of the second hydraulic motor 70 is greater than the second threshold value, thereby indicating that the load on the driven roller 66 of the merger attachment 64 is increased to a level that may indicate a likelihood of the crop material plugging the crop conditioning system 37, the controller 58 may control the actuation system 52 to increase the processing gap 50 from the desired processing gap 80 to the increased processing gap distance 82

The controller 58 may then determine when one of the current value of the first fluid pressure of the first hydraulic motor 60 decreases below the first threshold value, generally indicated by box 112 shown in FIG. 5, or when the current value of the second fluid pressure of the second hydraulic motor 70 decreases below the second threshold value, generally indicated by box 114 shown in FIG. 5. When both the current value of the first fluid pressure of the first hydraulic motor 60 is below the first threshold value and the current value of the second fluid pressure of the second hydraulic motor 70 is below the second threshold value, the controller 58 may communicate a control signal to the actuation system 52 to control the actuation system 52 to decrease the processing gap 50 from the increased processing gap distance 82 to the desired processing gap 80. The step of decreasing the increased processing gap distance 82 to the desired processing gap 80 is generally indicated by box 116 shown in FIG. 5.

It should be appreciated that if one of the first fluid pressure remains greater than the first threshold value or the second fluid pressure remains greater than the second threshold value, then the controller 58 may control the position of the actuation system 52 to maintain the increased processing gap distance 82. However, when both of the first fluid pressure is disposed at or decreases to a level less than the first threshold value and the second fluid pressure is disposed at or decreases to a level less than the second threshold value, then the controller 58 may communicate the control signal to the actuation system 52 to move the rotating element 44 of the crop conditioning system 37 and re-establish the desired roll gap to continue the desired level or amount of crop conditioning.

In some implementations, the processor 74 may be operable to execute the plug prevention algorithm 78 to determine a current magnitude of vibration in the one of the implement head 34 and the merger attachment 64 to which the motion sensor is attached from data sensed from the motion sensor. The controller 58 may then compare the current magnitude of vibration to a vibration threshold value, and control the actuation system to increase the processing gap 50 when the current magnitude of the vibration is greater than the vibration threshold value.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A windrower implement comprising:
a frame extending along a central longitudinal axis between a forward end and a rearward end relative to a direction of travel during operation;
an implement head attached to the frame proximate the forward end thereof, wherein the implement head includes a cutter configured for cutting standing crop material and a crop conditioning system having a rotating element configured for processing the crop material, wherein the implement head is configured to discharge the crop material from the crop conditioning system in a rearward direction along the central longitudinal axis;
an actuation system coupled to the rotating element of the crop conditioning system and selectively controllable to control a position of the rotating element relative to another component to define a processing gap between the rotating element and the another component for moving the crop material therethrough;
a first hydraulic motor coupled to the rotating element of the crop conditioning system, wherein the first hydraulic motor is operable in response to a first fluid pressure to rotate the rotating element of the crop conditioning system;
a controller including a processor and a memory having a plug prevention algorithm stored thereon, wherein the processor is operable to execute the plug prevention algorithm to:
determine a current value of the first fluid pressure of the first hydraulic motor;
compare the current value of the first fluid pressure of the first hydraulic motor to a first threshold value; and
control the actuation system to increase the processing gap from a desired processing gap when the current value of the first fluid pressure of the first hydraulic motor is greater than the first threshold value.

2. The windrower implement set forth in claim 1, wherein the processor is operable to execute the plug prevention algorithm to determine the desired processing gap.

3. The windrower implement set forth in claim 2, wherein the processor is operable to execute the plug prevention algorithm to determine the desired processing gap by receiving a commanded processing gap from an operator via an input device.

4. The windrower implement set forth in claim 2, wherein the processor is operable to execute the plug prevention algorithm to automatically determine the desired processing gap based on at least one sensed crop characteristic.

5. The windrower implement set forth in claim 1, wherein the processor is operable to execute the plug prevention algorithm to control the actuation system to decrease the processing gap to the desired processing gap when the current value of the first fluid pressure of the first hydraulic motor decreases below the first threshold value.

6. The windrower implement set forth in claim 1, further comprising a first pressure sensor configured for detecting fluid pressure at the first hydraulic motor and disposed in communication with the controller for communicating data thereto.

7. The windrower implement set forth in claim 1, further comprising a merger attachment coupled to the frame rearward of the implement head, wherein the merger attachment includes a driven roller supporting a conveyor positioned relative to the implement head to receive the crop material discharged from the implement head, and convey the crop material laterally relative to the central longitudinal axis to form a windrow laterally offset from the central longitudinal axis.

8. The windrower implement set forth in claim 7, further comprising a second hydraulic motor coupled to the driven roller of the merger attachment, wherein the second hydraulic motor is operable in response to a second fluid pressure to rotate the driven roller of the merger attachment.

9. The windrower implement set forth in claim 8, wherein the processor is operable to execute the plug prevention algorithm to:
determine a current value of the second fluid pressure of the second hydraulic motor;
compare the current value of the second fluid pressure of the second hydraulic motor to a second threshold value; and
control the actuation system to increase the processing gap from the desired processing gap when the current value of the second fluid pressure of the second hydraulic motor is greater than the second threshold value.

10. The windrower implement set forth in claim 9, wherein the processor is operable to execute the plug prevention algorithm to control the actuation system to decrease the processing gap to the desired processing gap when the current value of the second fluid pressure of the second hydraulic motor decreases below the second threshold value.

11. The windrower implement set forth in claim 7, further comprising a second pressure sensor configured for detecting fluid pressure at the second hydraulic motor and disposed in communication with the controller for communicating data thereto.

12. The windrower implement set forth in claim 7, further comprising a motion sensor coupled to one of the implement head and the merger attachment and operable to detect vibration of the one of the implement head and the merger attachment to which the motion sensor is attached.

13. The windrower implement set forth in claim 12, wherein the processor is operable to execute the plug prevention algorithm to:
determine a current magnitude of vibration in the one of the implement head and the merger attachment to which the motion sensor is attached from data sensed from the motion sensor;
compare the current magnitude of vibration to a vibration threshold value; and
control the actuation system to increase the processing gap when the current magnitude of the vibration is greater than the vibration threshold value.

14. The windrower implement set forth in claim 1, wherein the actuation system includes an actuator selectively moveable in response to a control signal from the controller.

15. A windrower implement comprising:
a frame extending along a central longitudinal axis between a forward end and a rearward end relative to a direction of travel during operation;
an implement head attached to the frame proximate the forward end thereof, wherein the implement head includes a cutter configured for cutting standing crop material and a crop conditioning system having a rotating element configured for processing the crop material, wherein the implement head is configured to discharge the crop material from the crop conditioning system in a rearward direction along the central longitudinal axis;
an actuation system coupled to the rotating element of the crop conditioning system and selectively controllable to control a position of the rotating element to define a processing gap between the rotating element and another component for receiving the crop material therethrough for processing;
a first hydraulic motor coupled to the rotating element of the crop conditioning system, wherein the first hydraulic motor is operable in response to a first fluid pressure to rotate the rotating element of the crop conditioning system;
a merger attachment coupled to the frame rearward of the implement head, wherein the merger attachment includes a driven roller supporting a conveyor positioned relative to the implement head to receive the crop material discharged from the implement head, and convey the crop material laterally relative to the central longitudinal axis to form a windrow laterally offset from the central longitudinal axis;
a second hydraulic motor coupled to the driven roller of the merger attachment, wherein the second hydraulic motor is operable in response to a second fluid pressure to rotate the driven roller of the merger attachment;
a controller including a processor and a memory having a plug prevention algorithm stored thereon, wherein the processor is operable to execute the plug prevention algorithm to:
determine a desired processing gap;
determine a current value of the second fluid pressure of the second hydraulic motor;
compare the current value of the second fluid pressure of the second hydraulic motor to a second threshold value; and
control the actuation system to increase the processing gap from the desired processing gap when the current value of the second fluid pressure of the second hydraulic motor is greater than the second threshold value.

16. The windrower implement set forth in claim 15, wherein the processor is operable to execute the plug prevention algorithm to control the actuation system to decrease the processing gap to the desired processing gap when the current value of the second fluid pressure of the second hydraulic motor decreases below the second threshold value.

17. The windrower implement set forth in claim 15, wherein the processor is operable to execute the plug prevention algorithm to:
determine a current value of the first fluid pressure of the first hydraulic motor;
compare the current value of the first fluid pressure of the first hydraulic motor to a first threshold value; and
control the actuation system to increase the processing gap from a desired processing gap when the current value of the first fluid pressure of the first hydraulic motor is greater than the first threshold value.

18. The windrower implement set forth in claim 17, wherein the processor is operable to execute the plug prevention algorithm to control the actuation system to decrease the processing gap to the desired processing gap when the current value of the first fluid pressure of the first hydraulic motor decreases below the first threshold value.

19. A controller for a windrower implement, the controller comprising:
a processor;
a memory having a plug prevention algorithm stored thereon, wherein the processor is operable to execute the plug prevention algorithm to:
determine a desired processing gap;
determine a current value of a first fluid pressure of a first hydraulic motor coupled to a rotating element of a crop conditioning system of the windrower implement;
compare the current value of the first fluid pressure of the first hydraulic motor to a first threshold value;
determine a current value of a second fluid pressure of a second hydraulic motor coupled to a driven roller of a merger attachment of the windrower implement;
compare the current value of the second fluid pressure of the second hydraulic motor to a second threshold value; and
control the actuation system to increase the processing gap from the desired processing gap when one of the current value of the first fluid pressure of the first hydraulic motor is greater than the first threshold value or when the current value of the second fluid pressure of the second hydraulic motor is greater than the second threshold value.

20. The controller set forth in claim 19, wherein the processor is operable to execute the plug prevention algorithm to control the actuation system to decrease the processing gap to the desired processing gap when the one of the current value of the first fluid pressure of the first hydraulic motor decreases below the first threshold value or the current value of the second fluid pressure of the second hydraulic motor decreases below the second threshold value, whereby both the current value of the first fluid pressure of the first hydraulic motor is below the first threshold value and the current value of the second fluid pressure of the second hydraulic motor is below the second threshold value.
